(19) United States
(12) Patent Application Publication
(10) Pub. No.: US 2008/0294913 A1
(43) Pub. Date: Nov. 27, 2008

(54) DISK ARRAY CONTROLLER, DISK ARRAY CONTROL METHOD AND STORAGE SYSTEM

(76) Inventors: Hiroshi NAKAGOE, Yokohama (JP); Toru Owada, Yokohama (JP); Yasushi Nagai, Fujisawa (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 12/014,250

(22) Filed: Jan. 15, 2008

(30) Foreign Application Priority Data
May 25, 2007 (JP) 2007-139589

(51) Int. Cl. H04L 9/06

(52) U.S. Cl. 713/193

(57) ABSTRACT

Provided is a disk array controller capable of speeding up the processing by simultaneously execution the encryption/decryption of a non parallel block cipher modes of operation. In a disk array controller for controlling a disk array according to a disk access request from a host system, a plurality of non parallel mode encryption/decryption target data are divided into a plurality of messages unrelated to the encryption/decryption processing, partitioning non parallel mode encryption/decryption target data belonging to the respective messages into a plurality of block data, storing each block data belonging to the respective messages by allocating it each line of Rnd[0] to Rnd[R−1] per message, and encrypting/decrypting block data corresponding to block data corresponding to a cell of the same column of each line among the block data stored in a data buffer simultaneously with the pipeline processing performed by a pipeline encryption/decryption circuit.

### CROSS REFERENCES

This application relates to and claims priority from Japanese Patent Application No. 2007-139589, filed on May 25, 2007, the entire disclosure of which is incorporated herein by reference.

### BACKGROUND

The present invention generally relates to encryption/decryption technology in information appliances, computers and the like, and in particular relates to encryption/decryption technology in a disk array controller or a storage system that stores data in a disk array as represented by RAID (Redundant Array of Inexpensive Disks).

Today, pursuant to the formulation of the Japanese version of the SOX law that sets forth the reinforcement of internal control of corporations, companies must protect and manage vast volumes of document data, and the self-installation and outsourcing of data centers capable of collectively managing large volumes of data are attracting attention. In a data center, data is redundantly stored in a disk array system as represented by RAID for speeding up the data access or protecting the stored data.

In recent years, information leakage in these data centers is becoming a problem. This information leakage can be classified into external crimes based on unauthorized access from the outside, and internal crimes such as theft of the HDD configuring the disk array. As one method of preventing information leakage caused by the theft of HDD, there is a method of encrypting the data to be stored in the HDD. Thereby, even if the HDD is carried outside from the data center, it is possible to invalidate access to the data before encryption unless the key used in such encryption is obtained.

Block cipher is often used for encrypting the data to be stored in a disk. Block cipher is a common key encryption method that partitions data into block data of a fixed length, encrypting such data using a key or IV (Initial Vector) in block units, and outputting encrypted data of the same length. As of the year 2007, AES (Advanced Encryption Standard) is the substantial global standard for such common key encryption method. AES is an encryption algorithm having a spin structure that repeats cipher processing and transposition processing for each unit known as a round.

With block cipher, a plurality of block cipher modes of operation are prepared since encryption is performed according to the usage. This block cipher modes of operation can be categorized into a mode without dependency between block data and capable of parallel processing of processing block data in a random sequence (hereinafter referred to as the “parallel block cipher modes of operation”), and a mode with dependency between block data and not capable of parallel processing where it must process block data in sequential order (hereinafter referred to as the “non parallel block cipher modes of operation”).

With the parallel block cipher modes of operation, since encryption is performed without any relationship between block data, encryption/decryption can be performed without being aware of the processing order of each block data; in other words, encryption/decryption can be performed in a random sequence. As the encryption/decryption processing in the parallel block cipher modes of operation, for instance, proposed is a method of processing the encryption/decryption at high speed by pipelining an encryption circuit per round, and inputting block data one after another in each column (refer to Japanese Patent Laid-Open Publication No. 2002-297031; “Patent Document 1”).

### SUMMARY

In the non parallel block cipher modes of operation, encryption is performed with a relationship between block data. An example of encrypting data D with CBC (Cipher Block Chaining), which is one of the non parallel block cipher modes of operation, is now explained. Incidentally, let it be assumed that data D is configured from block data Db[0] and Db[1].

With CBC encryption, before subjecting the first block data Db[0] to encryption processing, the exclusive OR (XOR) is acquired between Db[0] and IV, and (Db[0] XOR IV) is encrypted. Subsequently, upon encrypting the block data Db[1], C(Db[0] XOR IV) as the encryption result of foregoing (Db[0] XOR IV), and foregoing Db[1] are subject to XOR, and (Db[1] XOR C(Db[0] XOR IV)) is encrypted.

Nevertheless, with this kind of non parallel block cipher modes of operation, since subsequent block data is operated with some kind of method using the encryption result of block data processed previously, and the result thereof is encrypted, it is not possible to encrypt/decrypt in parallel a plurality of block data contained in the same data such as Db[0] and Db[1]. Thus, with the disk array system equipped with the encryption circuit described in Patent Document 1, since it is not possible to input block data one after another in a pipeline circuit when encrypting/decrypting data with the non parallel block cipher modes of operation, this process will be slower in comparison to the encryption/decryption performed with the parallel block cipher modes of operation.

Further, in a disk array system that stores data encrypted with a plurality of block cipher modes of operation, with the encryption circuit described in Patent Document 1, it is not possible to execute a plurality of block cipher modes of operation in parallel. As a disk array system that stores data encrypted with the block cipher modes of operation, for instance, there is a disk array system in which the block cipher modes of operation to be used will different depending on the client handling the data to be stored in the disk array system. In addition, as a system that performs encryption in disk sector units, there is a disk array system in which the block cipher modes of operation used for encrypting data to be stored in a disk where the sector length is a multiple length of block data, and the block cipher modes of operation used for encrypting data to be stored in a disk where the sector length is not a multiple length of block data are different.

When encrypting/decrypting each of the plurality of data with separate block cipher modes of operation, while performing the encryption/decryption processing of one block cipher modes of operation the encryption/decryption of the other block cipher modes of operation cannot be executed, an unused section will arise in the respective columns of the pipeline encryption circuit, and the encryption/decryption processing cannot be performed at high speed.

The present invention was devised in view of the foregoing circumstances. Thus, one object of this invention is to simultaneously execute the encryption/decryption of data of the non parallel block cipher modes of operation. Another object of the present invention is to simultaneously execute the encryption/decryption processing of data of the non parallel block cipher modes of operation and the encryption/decryption of data of the parallel block cipher modes of operation. A further object of the present invention is to prevent the occurrence of processing latency of encryption/decryption of data of one block cipher modes of operation when the processing of encryption/decryption of data of the other block cipher modes of operation is biased in the simultaneous execution of encryption/decryption of a plurality of block cipher modes of operation.

In order to achieve the foregoing objects, the present invention, upon controlling a disk array according to a disk access request from a host system, identifies the disk access request and manages data from the host system as write transfer data when the disk access request is a write request from the host system and manages data from the disk array as read transfer data when the disk access request is a read request from the host system, divides the write transfer data or the read transfer data under control thereof into a plurality of messages as data to be encrypted/decrypted and stores the data by in an input buffer by partitioning it into block units per message, when data of the respective messages stored in the input buffer has dependency between block data and is data based on a non parallel block cipher modes of operation that must be processed in sequential order, interleavely retrieves data of the respective messages from the input buffer in block units, and executing encryption/decryption processing to the retrieved data through a pipeline, and, when data of the respective messages stored in the input buffer has no dependency between blocks and includes data based on a parallel block cipher modes of operation that can be processed in a random sequence in addition to the data based on non parallel block cipher modes of operation, sequentially retrieves data of the respective messages from the input buffer in block units regarding the data based on parallel block cipher modes of operation, and executing encryption/decryption processing to each of the retrieved data through a pipeline.

Specifically, the present invention provides a disk array apparatus for controlling a disk array according to a disk access request from a host system. This disk array apparatus comprises a transfer data management unit for sending and receiving data to and from the host system or the disk array, and, by identifying the disk access request, managing data from the host system as write transfer data when the disk access request is a write request from the host system, and managing data from the disk array as read transfer data when the disk access request is a read request from the host system, an input buffer for dividing the write transfer data or the read transfer data under control of the transfer data management unit into a plurality of messages as data to be encrypted/decrypted, and storing the data by partitioning it into block units per message, an encryption/decryption processor for inputting in block units the data to be encrypted/decrypted stored in the input buffer, and executing encryption/decryption processing to the data input in block units, an output buffer for associating the data processed by the encryption/decryption processor with the host system or the disk array, and storing the data by dividing it into the plurality of messages, and a data transfer unit for sending and receiving data to and from the host system or the disk array, and, by identifying the disk access request, transferring data of the respective messages stored in the output buffer to the disk array when the disk access request is a write request from the host system, and transferring data of the respective messages stored in the output buffer to the host system when the disk access request is a read request from the host system. When data of the respective messages stored in the input buffer has dependency between block data and is data based on a non parallel block cipher modes of operation that must be processed in sequential order, the encryption/decryption processor interleavely retrieves data of the respective messages from the input buffer in block units, and executes encryption/decryption processing to the retrieved data through a pipeline.

In a preferred mode of the present invention, the input buffer divides a plurality of non parallel mode encryption/decryption target data into a plurality of messages unrelated to the encryption/decryption processing, partitions non parallel mode encryption/decryption target data belonging to the respective messages into a plurality of block data, and stores each block data belonging to the respective messages by allocating it to each line and each column per message, and the encryption/decryption processor encrypts/decrypts block data corresponding to a cell of the same column of each line of the input buffer simultaneously with the pipeline processing.

The present invention further provides a disk array apparatus for controlling a disk array according to a disk access request from a host system. This disk array apparatus comprises a transfer data management unit for sending and receiving data to and from the host system or the disk array, and, by identifying the disk access request, managing data from the host system as write transfer data when the disk access request is a write request from the host system, and managing data from the disk array as read transfer data when the disk access request is a read request from the host system, an input buffer for dividing the write transfer data or the read transfer data under control of the transfer data management unit into a plurality of messages as data to be encrypted/decrypted, and storing the data by partitioning it into block units per message, an encryption/decryption processor for inputting in block units the data to be encrypted/decrypted stored in the input buffer, and executing encryption/decryption processing to the data input in block units, an output buffer for associating the data processed by the encryption/decryption processor with the host system or the disk array, and storing the data by dividing it into the plurality of messages, and a data transfer unit for sending and receiving data to and from the host system or the disk array, and, by identifying the disk access request, transferring data of the respective messages stored in the output buffer to the disk array when the disk access request is a write request from the host system, and transferring data of the respective messages stored in the output buffer to the host system when the disk access request is a read request from the host system. When data of the respective messages stored in the input buffer has dependency between block data and is data based on a non parallel block cipher modes of operation that must be processed in sequential order, the encryption/decryption processor interleavely retrieves data of the respective messages from the input buffer in block units, and executes encryption/decryption processing to the retrieved data through a pipeline, and, when data of the respective messages stored in the input buffer has no dependency between blocks and includes data based on a parallel block cipher modes of operation that can be processed in a random sequence in addition to the data based on non parallel block cipher modes of operation, the encryption/decryption processor sequentially retrieves data of the respective messages from the input buffer in block units regarding the data based on parallel block cipher modes of operation, and executes encryption/decryption processing to each of the retrieved data through a pipeline.

In a preferred mode of the present invention, the input buffer respectively divides a plurality of non parallel mode encryption/decryption target data and a plurality of parallel mode encryption/decryption target data into a plurality of messages unrelated to the encryption/decryption processing, partitions non parallel mode encryption/decryption target data or parallel mode encryption/decryption target data belonging to the respective messages into a plurality of block data, and stores each block data belonging to the respective messages by allocating it to each line and each column per message, and the encryption/decryption processor encrypts/decrypts block data corresponding to a cell of the same column of each line of the messages containing the non parallel mode encryption/decryption target data simultaneously with the pipeline processing, and uses unused processing time arising during the encryption/decryption processing to encrypt/decrypt block data corresponding to a cell of the same column of each line of the messages containing the parallel mode encryption/decryption target data.

According to the present invention, it is possible to speed up the processing in proportion to the number of rounds of the loaded encryption algorithm.

Further, when encrypting/decrypting a plurality of block cipher modes of operation encryption/decryption target data, the user will be provided with optimal usage since latency below the threshold value set by the user will not occur in the encryption/decryption processing of one block cipher modes of operation.

### DESCRIPTION OF DRAWINGS

FIG. 1 is a block diagram showing an embodiment of the present invention;

FIG. 2 is a block diagram showing the system of storing data of the encryption key/IV/block cipher modes of operation in a buffer prepared at the frontend of an encryption/decryption circuit according to an embodiment of the present invention;

FIG. 3 is a flowchart explaining the data processing of a disk array controller according to an embodiment of the present invention;

FIG. 4 is a block diagram explaining the details of an encryption processor of the disk array controller according to an embodiment of the present invention;

FIG. 5 is a flowchart explaining the data output processing of an input controller;

FIG. 6 is a flowchart explaining the data encryption/decryption processing of a pipeline encryption/decryption circuit;

FIG. 7 is a flowchart explaining the data transfer processing of an output controller;

FIG. 8 is a block diagram showing another embodiment of the present invention;

FIG. 9 is a block diagram showing the system of storing data of the encryption key/IV/block cipher modes of operation in a buffer prepared at the frontend of an encryption/decryption circuit according to another embodiment of the present invention;

FIG. 10 is a flowchart explaining the data processing flow of a disk array controller according to an embodiment of the present invention; and

FIG. 11 is a flowchart explaining the data output processing of an input controller according to another embodiment of the present invention.

### DETAILED DESCRIPTION

### First Embodiment

The first embodiment of the present invention is now explained in detail with reference to the attached drawings.

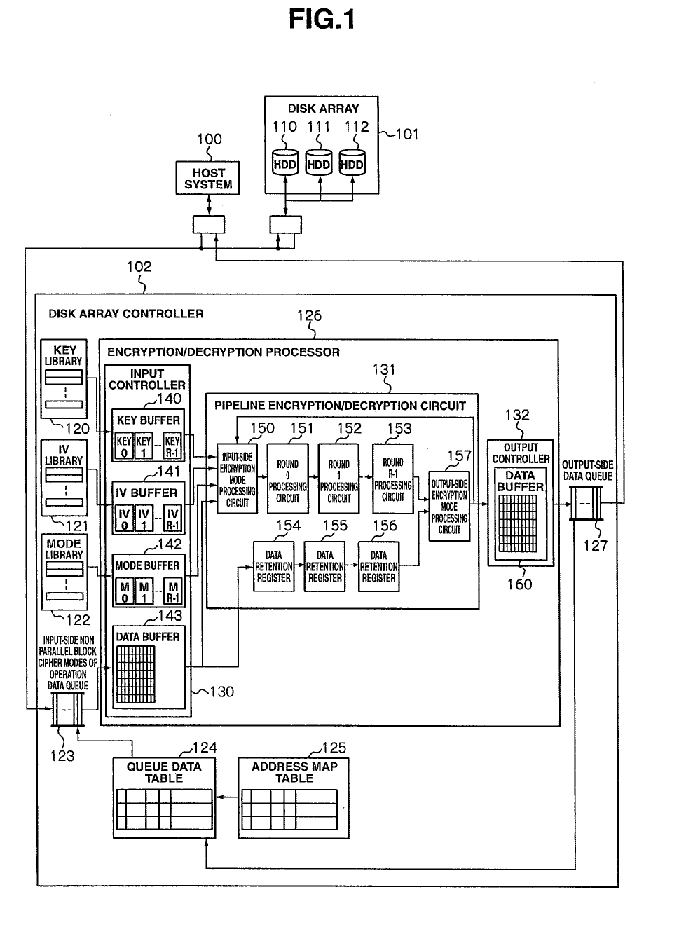

FIG. 1 is a configuration diagram showing a storage system according to the first embodiment of the present invention. In FIG. 1, the storage system comprises a host system 100, a disk array 101, and a disk array controller 102, and the host system 100 is configured as a host apparatus or a host computer such as an information appliance or a computer that uses data stored in the disk array 101, and sends and receives information to and from the disk array controller 102 via a communication network.

The disk array 101 is configured from disk drives 110 to 112. The disk array controller 102 controls the disk array 101, receives a disk access request from the host system 100, and reads and writes data. The disk array controller 102 is configured from a key library 120, an IV library 121, a block cipher modes of operation library 122, an input-side non parallel block cipher modes of operation data queue 123, a queue data table 124, an address map table 125, an encryption/decryption processor 126, and an output-side data queue 127.

The key library 120 stores the encryption key to be used upon encrypting data to be stored in the disk array 101 when a write request is sent from the host system 100, and stores the decryption key to be used upon decrypting data to be read from the disk array 101 and transferred to the host system 100 when a read request is sent from the host system 100.

The IV library 121 stores the IV to be used upon encrypting data to be stored in the disk array 101 when a write request is sent from the host system 100, and stores the IV to be used upon decrypting data to be read from the disk array 101 and transferred to the host system 100 when a read request is sent from the host system 100.

The block cipher modes of operation library 122 retains the block cipher modes of operation necessary upon encrypting data to be stored in the disk array 1010 when a write request is sent from the host system 100, and retains the block decipher modes of operation necessary upon decrypting data to be read from the disk array 101 and transferred to the host system 100 when a read request is sent from the host system 100.

The input-side non parallel block cipher modes of operation data queue 123 queues the non parallel mode encryption/decryption target data in the data transferred from the host system 100 when a write request is sent from the host system 100 and queues the non parallel block cipher modes of operation encryption/decryption target data in the data according to an address designated during the disk access request of the host system when a read request is sent from the host system 100 based on the disk array controller 102.

Incidentally, the size of data to be queued in the input-side non parallel block cipher modes of operation data queue 123 is of a sector length of the disk drives 110 to 112 configuring the disk array 101. Further, let it be assumed that there is no relationship concerning the encryption/decryption processing between the queued data. For example, when queuing a plurality of data of the CBC block cipher modes of operation, let it be assumed that the start block data in each data to be queued is subject to XOR with IV, and the encryption/decryption of the XOR operation result is performed.

The queue data table 124 contains a data queuing sequence, a write/read address, a write/read data size, encryption key information to be used in the data encryption/decryption, IV information to be used in the data encryption/decryption, the block cipher modes of operation of the data encryption/decryption, and other information set by the disk array controller 102.

The address map table 125 includes a plurality of encryption keys differing in a disk area, a plurality of IVs differing in a disk area and a plurality of block cipher modes of operation differing in a disk area in relation to the disk address of data to be stored in the disk array 101, and is referred to when the disk array controller 102 creates the queue data table 124.

The encryption/decryption processor 126 performs encryption/decryption processing of data to be transferred from the input-side non parallel block cipher modes of operation data queue 123 by the disk array controller 102. The output-side data queue 127 queues the data to be output from the encryption/decryption processor 126.

The encryption/decryption processor 126 is configured from an input controller 130, a pipeline encryption/decryption circuit 131, and an output controller 132. The input controller 130 is configured from an encryption key buffer 140, an IV buffer 141, a block cipher modes of operation buffer 142, and a data buffer 143. The input controller 130 stores the encryption key transferred from the encryption key library 120 in the encryption key buffer 140, stores the IV transferred from the IV library 121 in the IV buffer 141, stores the block cipher modes of operation information transferred from the block cipher modes of operation library 122 in the block cipher modes of operation 142, and stores the data transferred from the input-side non parallel block cipher modes of operation data queue 123 in the data buffer 143.

Incidentally, the encryption key buffer 140 is able to retain a maximum of R-number of encryption keys, although this will differ depending on the buffer capacity, the IV buffer 141 is able to retain a maximum of R-number of IVs, although this will differ depending on the buffer capacity, and the block cipher modes of operation buffer 142 is able to retain a maximum of R-number of block cipher modes of operation information, although this will differ depending on the buffer capacity.

Here, R is an arbitrary integer to be decided based on the encryption algorithm. For example, in the case of AES using an encryption key having a key length of 128 bit, R is 10. Further, the data buffer 143 adopts a matrix structure, and is at maximum R lines×Ss/Sb columns, although this will differ depending on the buffer capacity. Here, Ss represents the sector length of the disk drives 110 to 112 configuring the disk array 101. Further, Sb represents the block length as the encryption/decryption processing unit of the loaded encryption algorithm, and, for instance, in the case of AES, Sb is 16 bytes. Data to be transferred from the data buffer 143 to the pipeline encryption/decryption circuit 131 is transferred in block data units as the unit of encryption processing.

The pipeline encryption/decryption circuit 131 is configured from an input-side block cipher modes of operation processing circuit 150, round processing circuits 151 to 153, data retention registers 154 to 156, and an output-side block cipher modes of operation processing circuit 157. The pipeline encryption/decryption circuit 131 uses the encryption key, IV and block cipher modes of operation transferred from the input controller 130 to encrypt the data transferred from the input controller 130 when a write request is sent from the host system 100, and decrypt the data transferred from the input controller 130 when a read request is sent from the host system 100.

In the encryption/decryption processing of the pipeline encryption/decryption circuit 131, the input-side block cipher modes of operation processing circuit 150, before inputting data into the round 0 processing circuit 151, performs processing of the block cipher modes of operation in which data to be transferred from the input controller 130 needs to be processed. For example, during the encryption of the CBC block cipher modes of operation, when the data to be transferred from the data buffer 143 is start block data, IV to be transferred from the IV buffer 141 and block data to be transferred from the data buffer 143 are subject to XOR, the XOR operation result is transferred to the round 0 processing circuit 151. When the data to be transferred from the data buffer 143 is block data other than the start block data, block data to be output from the output-side block cipher modes of operation processing circuit 157 and block data to be transferred from the data buffer 143 are subject to XOR, and the XOR operation result is transferred to the round 0 processing circuit 151.

The round 0 to R−1 processing circuits 151 to 153 are circuits for performing each round processing of the encryption algorithm having a spin structure, and adopt a pipeline structure strung together like beads. When loading AES as the encryption algorithm in the round 0 to R−1 processing circuits 151 to 153, the processing time of each round will be the same, and the input/output timing of the round 0 to R−1 processing circuits 151 to 153 will be the same. Even when loading an encryption algorithm in which the processing time of each round is different, the input/output timing of the round 0 to R−1 processing circuits 151 to 153 can be made to be the same by matching the processing time of each round with the processing time of the round processing circuit that takes the maximum processing time.

The data retention register 154 inputs data that is output from the data buffer 143 at a timing in which data output from the input-side block cipher modes of operation processing circuit 150 is input to the round 0 processing circuit 151, and the data retention register 154 outputs data that it was retaining at a timing when the processing in the round 0 processing circuit 151 is complete and the processing result is output.

Similarly, the data retention register 155 inputs data that is output from the data retention register 154 at a timing in which data is input from the round 0 processing circuit 151 to the round 1 processing circuit 152, and outputs data that it was retaining at a timing when the processing in the round 1 processing circuit 152 is complete and the processing result is output.

Similarly, the data retention register 156 inputs data at a timing in which data is input to the round R−1 processing circuit 153, and outputs data that it was retaining at a timing when the processing in the round R−1 processing circuit 153 is complete and the processing result is output.

The output-side block cipher modes of operation processing circuit 157 inputs data to be output from the round R−1 processing circuit 153 and data to be output from the data retention register 156, and, before outputting the data to the output controller 132, performs processing of the block cipher modes of operation in which data to be output from the round R−1 processing circuit 153 needs to be processed. For example, during the encryption of the CBC block cipher modes of operation, data to be output from the round R−1 processing circuit 153 will be output, in an unprocessed state, to the output controller 132 and the input-side block cipher modes of operation processing circuit 150.

Further, for instance, during the encryption of the OFB (Output Feed Back) block cipher modes of operation, data to be output from the round R−1 processing circuit 153 and data to be output from the data retention register 156 are subject to XOR, and the XOR operation result is output to the output controller 132 and the input-side block cipher modes of operation processing circuit 150.

The output controller 132 is configured from a data buffer 160. The data buffer 160 adopts a matrix structure, and is at maximum R lines×Ss/Sb columns, although this will differ depending on the buffer capacity. The size of the data buffer 160 is the same as the data buffer 143. The output controller 132 temporarily stores the block data to be output from the pipeline encryption/decryption circuit 131 in the data buffer 160, and transfers the data to the output-side data queue 127 at the time when the data to be stored in the 1 line becomes Ss.

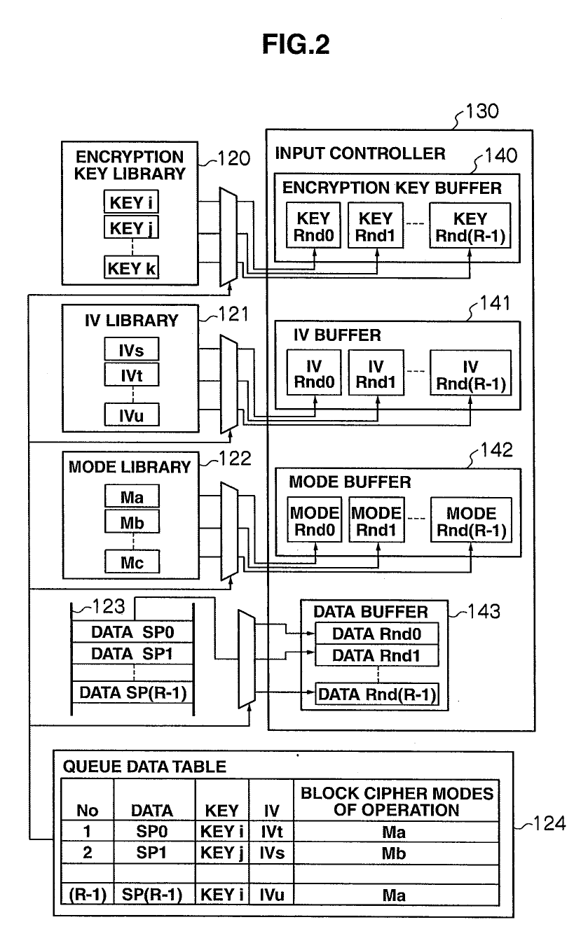

The encryption key library 120, the IV library 121, the block cipher modes of operation library 122, and the input-side non parallel block cipher modes of operation data queue 123 in the disk array controller 102, and the interface of the input controller 130 are now explained with reference to FIG. 2.

FIG. 2 shows the status of queuing data SP0 to SP(R−1) in the non parallel block cipher modes of operation data queue 123. In FIG. 2, the encryption key library 120 is connected to the encryption key buffer 140 in the input controller 130, and the disk array controller 102 outputs the corresponding encryption key to key Rnd0 or key Rnd1, key Rnd(R−1) in the encryption key buffer 140 according to the queuing sequence of the queue data table 124. In FIG. 2, key i in the encryption key library 120 is output to key Rnd0, key j in the encryption key library 120 is output to key Rnd1, and key i in the encryption key library 120 is output to key Rnd(R−1).

The IV library 121 is connected to the IV buffer 141 in the input controller 130, and the disk array controller 102 outputs the corresponding IV to IV Rnd0 or IV Rnd1, IV Rnd(R−1) in the IV buffer 141 according to the queuing sequence of the queue data table 124. In FIG. 2, IVs in the IV library 121 is output to IV Rnd0, IVt in the IV library 121 is output to IV Rnd1, and IVu in the IV library 120 is output to IV Rnd(R−1).

The block cipher modes of operation library 122 is connected to the block cipher modes of operation buffer 142 in the input controller 130, and the disk array controller 102 outputs the corresponding block cipher modes of operation to mode Rnd0 or [symbol] mode Rnd1, mode Rnd(R−1) in the block cipher modes of operation buffer 142 according to the queuing sequence of the queue data table 124. In FIG. 2, Ma in the block cipher modes of operation library 122 is output to mode Rnd0, Mb in the block cipher modes of operation library 122 is output to mode Rnd1, and Mc in the block cipher modes of operation library 122 is output to key Rnd(R−1). Incidentally, Ma and Mb show one type of non parallel block cipher modes of operation.

The input-side non parallel block cipher modes of operation data queue 123 is connected to the data buffer 143 in the input controller 130, and the disk array controller 102 outputs the corresponding data to data Rnd0 or data Rnd1, data Rnd(R−1) in the data buffer 143 according to the queuing sequence of the queue data table 124. In FIG. 2, data SP0 in the input-side non parallel block cipher modes of operation data queue 123 is output data Rnd0, data SP1 in the input-side non parallel block cipher modes of operation data queue 123 is output to data Rnd1, and data SP(R−1) in the input-side non parallel block cipher modes of operation data queue 123 is output to data Rnd(R−1).

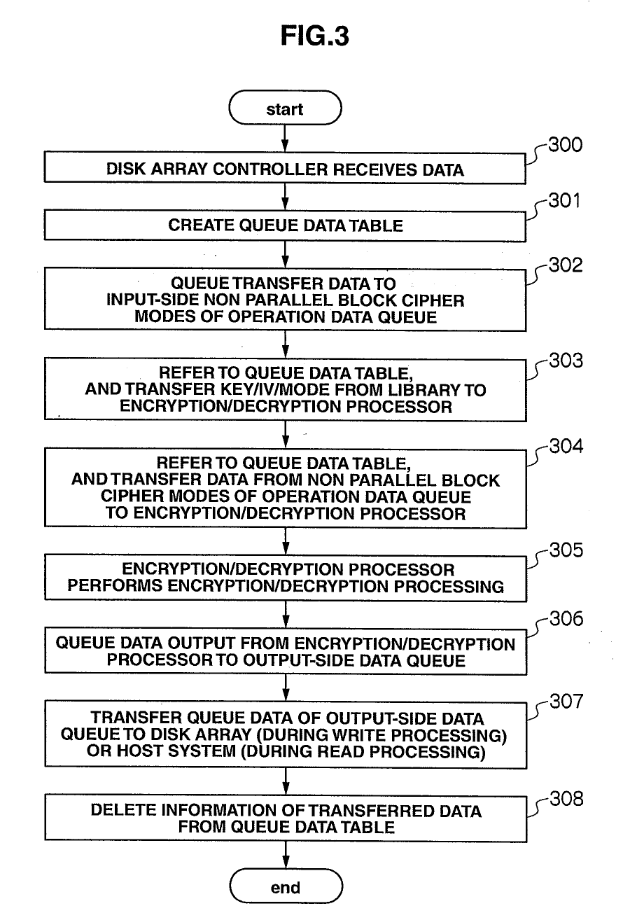

The data transfer processing to be performed by the disk array controller 102 is now explained with reference to FIG. 3. FIG. 3 shows the processing flow when a write request or a read request from the host system 100 is sent to the disk array controller 102.

The disk array controller 102 receives the transfer data transferred from the host system 100 when a write request is sent from the host system 100, and receives the transfer data transferred from the disk array 101 when a read request is sent from the host system 100 (step 300). Here, the data count of the foregoing transferred transfer data is set as N. Incidentally, N is an arbitrary integer that is less than the data count that can be queued in the non parallel block cipher modes of operation data queue 123.

The disk array controller 102 refers to the address map table 125, and, according to the disk access address/size of the write/read request from the host system 100, sets information of the corresponding encryption key, IV, and block cipher modes of operation together with information of the N-number of transferred transfer data in the queue data table 124 (step 301). Incidentally, information of the transfer data is created in the sequence of the transferred data in the queue data table 124.

Subsequently, the disk array controller 102 queues the data transferred to the input-side non parallel block cipher modes of operation data queue 123 according to the data transfer sequence (step 302), thereafter refers to the queue data table 124, transfers the encryption key from the encryption key library 120 to the encryption buffer 140 according to the sequence of the queued data, transfers the IV from the IV library 121 to the IV buffer 141, and transfers the block cipher modes of operation information from the block cipher modes of operation library 122 to the block cipher modes of operation buffer 142 (step 303).

Similarly, the disk array controller 102 refers to the queue data table 124, and transfers as many data as possible that was queued in the non parallel block cipher modes of operation data queue 123 to the data buffer 143 according to the sequence of the queued data (step 304). Here, the encryption/decryption processor 126 in the disk array controller 102 uses the encryption key set in the encryption key buffer 140, the IV set in the IV buffer 141 and the block cipher modes of operation set in the block cipher modes of operation buffer 142 to perform the encryption/decryption processing of data stored in the data buffer 143 (step 305). This step 305 will be described in detail later.

Meanwhile, the disk array controller 102 queues the encryption/decryption result data output from the encryption/decryption processor 126 in the output-side data queue 127 (step 306), transfers the queued data to the disk array 101 when a write request is sent from the host system 100, transfers the queued data to the host system 100 when a read request is sent from the host system 100 (step 307), deletes information concerning the transferred data from the queue data table 308 (step 308), and then ends the processing in this routine.

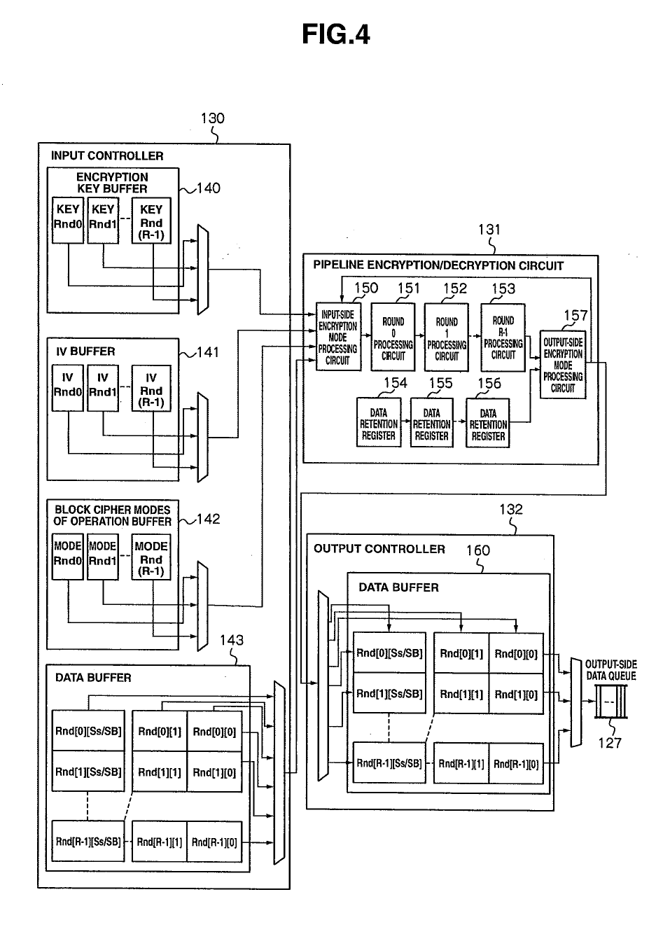

The data encryption/decryption processing to be performed by the encryption/decryption processor 126 is now explained with reference to FIG. 4. FIG. 4 shows a detailed internal block diagram of the encryption processor 126. In FIG. 4, upon processing the data of Rnd[0] line of the data buffer, the input controller 130 outputs the encryption key retained in key Rnd0 of the encryption key buffer 140 to the input-side block cipher modes of operation processing circuit 150. Similarly, upon processing the data of Rnd[1] line of the data buffer, the input controller 130 outputs the encryption key retained in key Rnd1 of the encryption key buffer 140 to the input-side block cipher modes of operation processing circuit 150, and, upon processing the data of Rnd[R−1] line of the data buffer, outputs the encryption key retained in key Rnd(R−1) of the encryption key buffer 140 to the input-side block cipher modes of operation processing circuit 150.

Also in the I/O operation of the IV buffer 141, upon processing the data of Rnd[0] line of the data buffer, the input controller 130 outputs the IV retained in IV Rnd0 of the IV buffer 141 to the input-side block cipher modes of operation processing circuit 150, and, upon processing the data of Rnd[1] line of the data buffer, outputs the IV retained in IV Rnd1 of the IV buffer 141 to the input-side block cipher modes of operation processing circuit 150, and, upon processing the data of Rnd[R−1] line of the data buffer, outputs the IV retained in IV Rnd(R−1) of the IV buffer 141 to the input-side block cipher modes of operation processing circuit 150.

Also in the I/O operation of the block cipher modes of operation buffer 142, upon processing the data of Rnd[0] line of the data buffer, the input controller 130 outputs the block cipher modes of operation information retained in mode Rnd0 of the block cipher modes of operation buffer 142 to the input-side block cipher modes of operation processing circuit 150, and, upon processing data of Rnd[1] line of the data buffer, outputs the block cipher modes of operation information retained in mode Rnd1 of the block cipher modes of operation buffer 142 to the input-side block cipher modes of operation processing circuit 150, and, upon processing the data of Rnd[R−1] line of the data buffer, outputs the block cipher modes of operation information retained in mode Rnd(R−1) of the block cipher modes of operation buffer 142 to the input-side block cipher modes of operation processing circuit 150.

The data buffer 143 has a matrix structure configured from cells of Rnd[0][0] to Rnd[R−1][Ss/Sb], and is capable of outputting data from all matrix cells to the input-side block cipher modes of operation processing circuit 150.

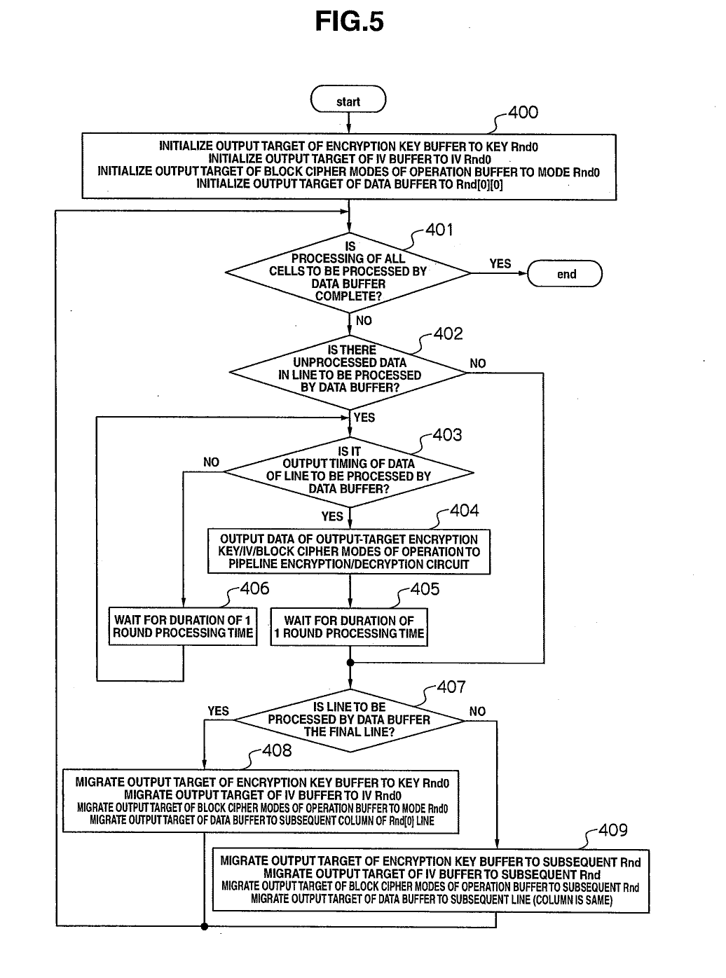

The data output processing for outputting data to the pipeline encryption/decryption circuit 131 of the input controller 130 is now explained with reference to FIG. 5. FIG. 5 shows a flowchart of the data output processing for outputting data to the pipeline encryption/decryption circuit 131 of the input controller 130.

The input controller 130 initializes the output target in the encryption key buffer 140, the IV buffer 141, and the block cipher modes of operation buffer 142 to Rnd0, initializes the output target of the data buffer 143 to Rnd[0][0] (step 400), subsequently determines whether there is a cell to be processed by the data buffer 143 (step 401), ends the processing if step 401 is true, determines whether there is unprocessed data in the current processing target line of the data buffer 143 if step 401 is false (step 402), determines whether it is the timing to output data of the processing target line of the data buffer 143 if step 402 is true (step 403), and proceeds to step 407 if step 402 is false.

The input controller 130, at step 403, determines that the timing of outputting block data of a column (current processing target column−1) in the current processing target line from the output-side block cipher modes of operation processing circuit 157 to the input-side block cipher modes of operation processing circuit 150 to be a true timing; that is, it determines that the timing after R×round processing time from the time block address of a column (current processing target column−1) is output to be a true timing. If step 403 is true, data of the encryption key, IV and block cipher modes of operation information of the output target is output to the pipeline encryption/decryption circuit 131 (step 404). If the processing time at step 404 is less than the maximum processing time in the round processing circuits 151 to 153, the input controller 130 waits until the processing time of 1 round lapses (step 405), waits until the processing time of 1 round lapses if step 403 is false (step 406), and repeats step 403 and step 406 until step 403 becomes true.

Subsequently, the input controller 130 determines whether the current processing target line in the data buffer 143 is the final line (step 407), and, if step 407 is true, sets the output target of the encryption key buffer 140, the IV buffer 141 and the block cipher modes of operation buffer 142 to Rnd0, and migrates the output target of the data buffer 143 to a cell of a subsequent column of Rnd[0] line (step 408). If step 407 is false, the input controller 130 sets the output target of the encryption key buffer 140, the IV buffer 141 and the block cipher modes of operation buffer 142 to the subsequent Rnd, migrates the output target of the data buffer 143 to a cell of the same column of a subsequent line (step 409), and repeats step 401 to 409. When step 401 becomes true, the input controller 130 ends this processing.

In other words, the input controller 130 divides a plurality of non parallel mode encryption/decryption target data into a plurality of messages (or “groups”) unrelated to the encryption/decryption processing, partitions the non parallel mode encryption/decryption target data belonging to the respective messages into a plurality of block data, and outputs block data corresponding to a cell of the same column of each line when each block data belonging to the respective messages is allocated to each line of Rnd[0] to Rnd[R−1] per message to the pipeline encryption/decryption circuit 131 in accordance with the pipeline processing.

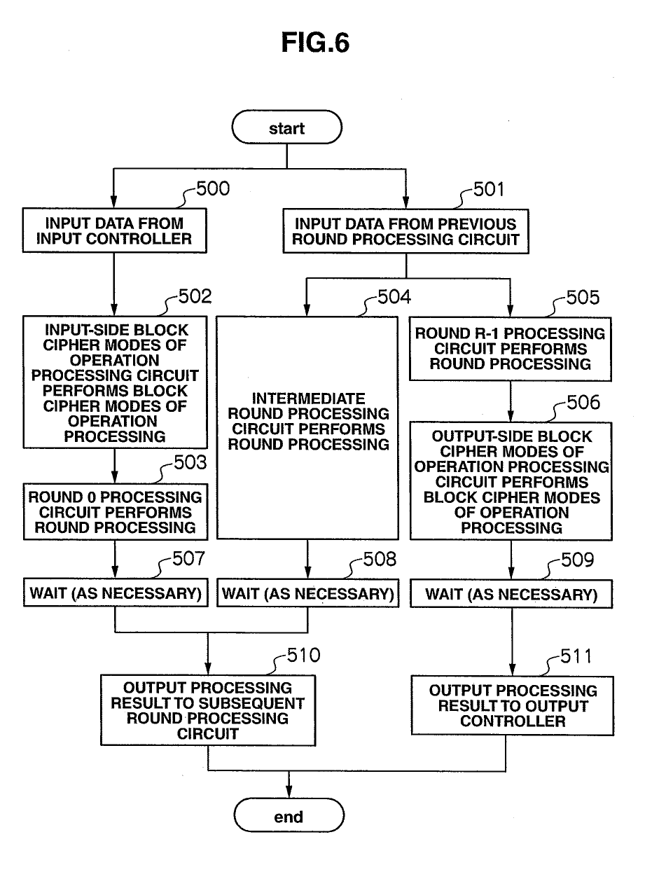

The data encryption/decryption processing of the pipeline encryption/decryption circuit 131 is now explained with reference to FIG. 6. FIG. 6 shows a flowchart of the data encryption/decryption processing to be performed by the pipeline encryption/decryption circuit 131.

The pipeline encryption/decryption circuit 131 simultaneously executes step 500 and step 501. At step 500, the input-side block cipher modes of operation processing circuit 150 receives data from the input controller 130, and at step 501, the round 1 processing circuit 152 inputs data from the round 0 processing circuit 151, and the round R−1 processing circuit 153 inputs data from the immediately preceding round processing circuit.

After the processing at step 500 and step 501 is complete, the pipeline encryption/decryption circuit 131 executes step 502 to 506. Incidentally, processing of step 502 and step 503, processing of step 504, and processing of step 505 and step 506 are executed simultaneously.

Foremost, at step 502, the input-side block cipher modes of operation processing circuit 150 performs an arithmetical operation unique to the block cipher modes of operation to the data and IV input at step 500 according to the block cipher modes of operation information to be simultaneously input, and outputs the result to the round 0 processing circuit 151. At step 503, the round 0 processing circuit 151 performs processing unique to round 0 to the data output from the input-side block cipher modes of operation processing circuit 150 at step 502.

At step 504, the round 1 processing circuit 152 executes processing unique to round 1 to the output data from the round 0 processing circuit 151 obtained at step 501.

At step 505, the round R−1 processing circuit 153 executes processing unique to round R−1 to the output data from the immediately preceding round processing circuit obtained at step 501. At step 506, the output-side block cipher modes of operation processing circuit 157 performs an arithmetical operation unique to the block cipher modes of operation to the output data from the round R−1 processing circuit 153 obtained at step 505 using the data to be simultaneously input from the data retention register 156.

After the processing at step 502 to step 506 is complete, the pipeline encryption/decryption circuit 131 simultaneously executes step 507 to step 509. The wait processing at step 507 to step 509 will be required when loading an encryption algorithm in which each round processing is different.

The pipeline encryption/decryption circuit 131, at step 507, waits up to the maximum processing time to be consumed in the other processing to be simultaneously executed when the processing time in the input-side block cipher modes of operation processing circuit 150 and the round 0 processing circuit 151 is shorter than the other processing to be executed simultaneously. Similarly, at step 508, the pipeline encryption/decryption circuit 131 waits up to the maximum processing time to be consumed in the other processing to be simultaneously executed when the processing time in the round 1 processing circuit 152 is shorter than the other processing to be executed simultaneously. Further, at step 509, the pipeline encryption/decryption circuit 131 waits up to the maximum processing time to be consumed in the other processing to be simultaneously executed when the processing time in the round R−1 processing circuit 153 and the output-side block cipher modes of operation processing circuit 157 is shorter than the other processing to be executed simultaneously.

With the pipeline encryption/decryption circuit 131, at step 510, a round processing circuit other than the round R−1 processing circuit 153 outputs the processing result to the subsequent round processing circuit, and at step 511, the output-side block cipher modes of operation processing circuit 157 outputs the processing result to the output controller 132. Incidentally, the processing circuits of round 2 to round R−2 will operate the same as the foregoing round 1 processing circuit 152.

In other words, the pipeline encryption/decryption circuit 131 divides a plurality of non parallel mode encryption/decryption target data into a plurality of messages unrelated to the encryption/decryption processing, partitions the non parallel mode encryption/decryption target data belonging to the respective messages into a plurality of block data, and executes encryption/decryption processing to block data corresponding to a cell of the same column of each line when each block area belonging to the respective messages is allocated to each line of Rnd[0] to Rnd[R−1] per message simultaneously with the pipeline processing performed by each round 0 to R−1 processing circuit.

Here, when the data of the respective messages stored in the data buffer 143 had dependency between block data and is data based on the non parallel block cipher modes of operation which must be processed in sequential order, the pipeline encryption/decryption circuit 131, as the encryption/decryption processor, interleavely retrieves the data of the respective messages from the data buffer 143 in block units, and executes encryption/decryption processing to the retrieved data through a pipeline.

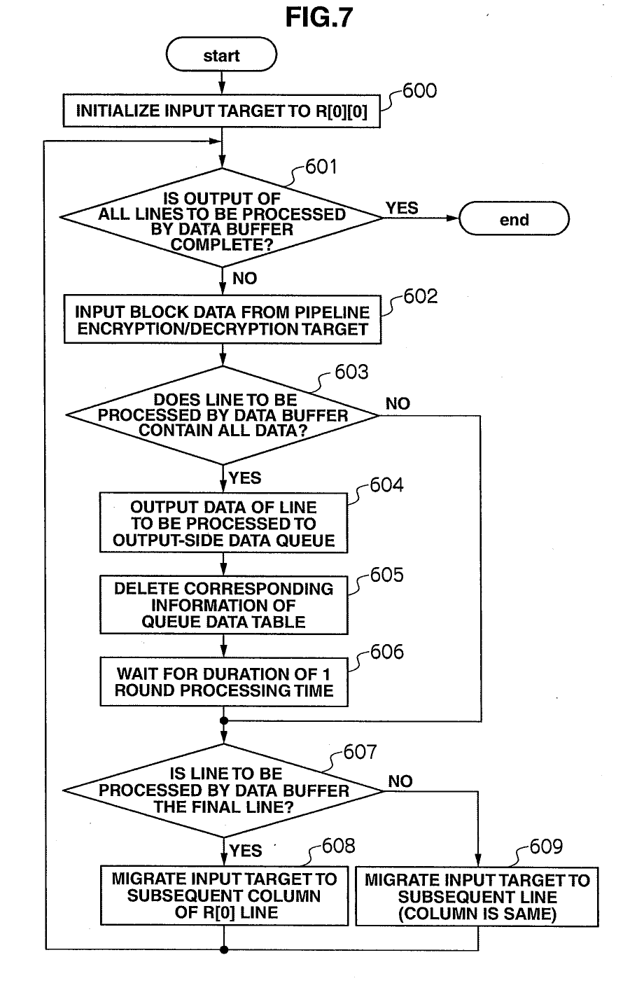

The data transfer processing to be performed by the output controller 132 is now explained with reference to FIG. 7. FIG. 7 shows a flowchart of the data transfer processing to be performed by the output controller 132. In FIG. 7, the output controller 132 initializes the input target cell in the data buffer 160 to Rnd[0][0] (step 600), and determines whether output to the output-side data queue 127 is complete regarding all lines to be processed in the data buffer 160 (step 601).

The output controller 132, if step 601 is false, inputs the block data to be output from the pipeline encryption/decryption circuit 131 (step 602), subsequently determines whether data has been filled in all columns of the current processing target line (step 603), and, if step 603 is true, outputs the processing target line data to the output-side data queue 127 (step 604).

Subsequently, the output controller 132 deletes information of output data from the queue data table 124 (step 605), waits for the maximum round processing time to lapse when the processing time at step 604 and step 605 is shorter than the maximum round processing time (step 606), determines whether the current processing target line in the data buffer 160 is the final line (step 607), and migrates the output target of the data buffer 160 to a cell of a subsequent column of Rnd[0] line if step 607 is true (step 608). The output controller 132, if step 607 is false, migrates the output target of the data buffer 160 to a cell of the same column of a subsequent line (step 609), repeats step 601 to step 609, and ends this processing when step 601 becomes true.

In other words, the output controller 132 divides a plurality of non parallel mode encryption/decryption target data into a plurality of messages unrelated to the encryption/decryption processing, partitions the non parallel mode encryption/decryption target data belonging to the respective messages into a plurality of block data, and outputs block data corresponding to a cell of the same column of each line when each block data belonging to the respective messages is allocated to each line of Rnd[0] to Rnd[R−1] for each message to the output-side data queue 127 in accordance with the processing timing of pipelining.

As described above, since the disk array controller 102 divides a plurality of non parallel mode encryption/decryption target data into a plurality of messages unrelated to the encryption/decryption processing, partitions the non parallel mode encryption/decryption target data belonging to the respective messages into a plurality of block data, and simultaneously encrypts/decrypts block data corresponding to a cell of the same column of each line when each block data belonging to the respective messages is allocated to each line of Rnd[0] to Rnd[R−1] for each message simultaneously with the pipeline processing, the present invention will be R-times faster when compared with the storage system applying Patent Document 1 of the conventional technology.

Further, in the first embodiment, although the input controller 130 was equipped with R-number of encryption keys, R-number of IVs, R-number of block cipher modes of operation information, and R-number of buffers capable of retaining data, if performance deterioration can be tolerated, it is possible to lower the buffer capacity to be less than R, whereby costs can be reduced. Moreover, the encryption/decryption processing throughput will be 1 to R times greater according to the buffer capacity in comparison to Patent Document 1 as the conventional technology.

### Second Embodiment

The second embodiment of the present invention is now explained in detail with reference to the attached drawings.

In this embodiment, the simultaneous execution of data encryption of the non parallel block cipher modes of operation and data encryption of the parallel block cipher modes of operation is explained in detail.

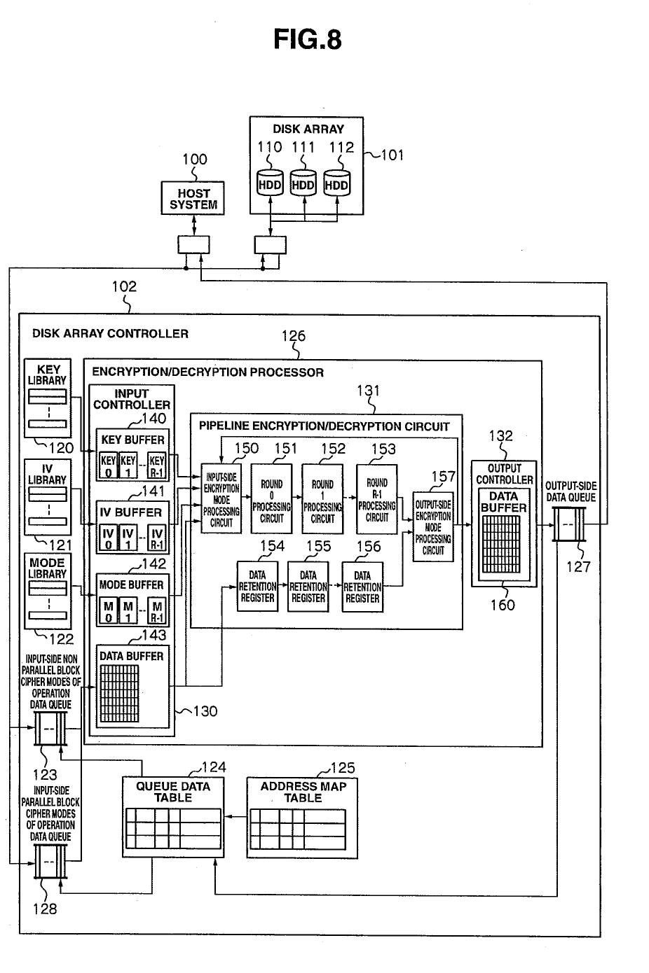

The disk array controller 102 shown in FIG. 8 has a structure in which an input-side parallel block cipher modes of operation data queue 128 is added to FIG. 1 of the first embodiment. The input-side parallel block cipher modes of operation data queue 128 queues the parallel mode encryption/decryption target data among the data transferred from the host system 100 when a write request is sent from the host system 100 and queues, from the disk array 101, the parallel block cipher modes of operation encryption/decryption target data among the data according to an address designated during the disk access request of the host system 100 when a read request is sent from the host system based on the disk array controller 102. Incidentally, the size of data to be queued in the input-side parallel block cipher modes of operation data queue 128 is of a sector length of the disk drives 110 to 112 configuring the disk array 101.

Further, the input controller 130 stores the encryption key transferred from the encryption key library 120 in its internal encryption key buffer 140, stores the IV transferred from the IV library 121 in its internal IV buffer 141, stores the block cipher modes of operation information transferred from the block cipher modes of operation library 122 in its internal block cipher modes of operation 142, and stores the data transferred from the input-side non parallel block cipher modes of operation data queue 123 and the parallel block cipher modes of operation data queue 128 in its internal data buffer 143. Incidentally, in FIG. 8, all blocks other than the input-side parallel block cipher modes of operation data queue 128 and the input controller 130 are the same as FIG. 1 of the first embodiment.

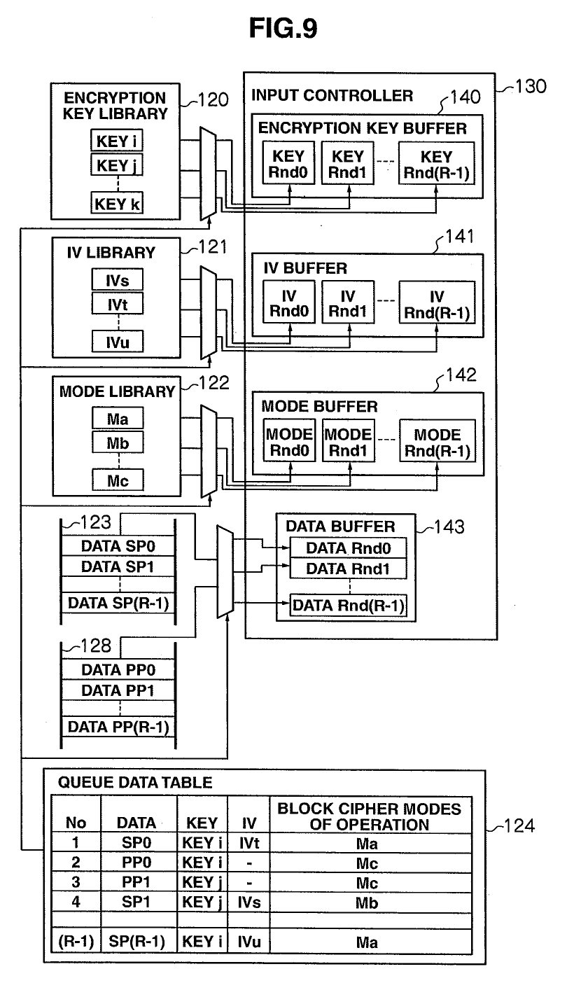

FIG. 9 shows the status of queuing data SP0 to SP(R−1) in the non parallel block cipher modes of operation data queue 123 and queuing data PP0 to PP(R−1) in the parallel block cipher modes of operation data queue 128, and has a structure in the input-side parallel block cipher modes of operation data queue 128 is added to FIG. 2 of the first embodiment. Incidentally, in FIG. 9, Mc is one type of parallel block cipher modes of operation, and the input-side non parallel block cipher modes of operation data queue 123 and the input-side parallel block cipher modes of operation data queue 128 are connected to the data buffer 143 in the input controller 130.

Specifically, the disk array controller 102 according to the present embodiment sequentially outputs corresponding data from the non parallel block cipher modes of operation data queue 123 to start Rnd0 line of the data buffer 143 according to the queuing sequence of the non parallel block cipher modes of operation data in the data queue table 112 in a quantity of a that satisfies the condition shown in Formula 1 (Condition 1) below, and, thereafter, sequentially outputs corresponding data from the parallel block cipher modes of operation data queue 128 to the subsequent line containing the non parallel block cipher modes of operation data of the data buffer 143 in a quantity of (Nc−α) according to the queuing sequence of the parallel block cipher modes of operation data in the data queue table 112 of (Nc−α), in which α is subtracted from the number of lines Nc of the data buffer 143, is 0 or greater. Incidentally, in FIG. 9, Nc is R.

[Formula 1]

```
If (latency<LATENCY)
    α=Nc−Nnp
else
    α=1
```

Nnp is Nnp=MAX(nₙₚ) in Nnp that satisfies the following:

CEIL(N_{cbc}÷(Nc−(nₙₚ−1)))×Ss÷Sb×Nr +(N_{ecb}−(Nc×CEIL(N_{cbc}÷(Nc−(nₙₚ−1)))+N_{cbc}))×Ss÷Sb =CEIL(N_{cbc}÷(Nc−nₙₚ))×Ss÷Sb×Nr +(N_{ecb}−(Nc×CEIL(N_{cbc}÷(Nc−nₙₚ))+N_{cbc}))×Ss÷Sb

In FIG. 9, when R is 10, α=5, and the disk array controller 102 sequentially outputs up to the 5^{th} data counted from SP0 to the 5^{th} line from data Rnd0 from the input-side non parallel block cipher modes of operation data queue 123 during the first encryption/decryption processing, and sequentially outputs up to the 5^{th} data counted from PP0 to the remaining 5 lines of the data buffer 143 from the input-side parallel block cipher modes of operation data queue 128.

In Formula 1 (Condition 1), latency shows the time that none of the parallel block cipher modes of operation encryption/decryption target data is output to the data buffer 143 since it has been queued in the parallel block cipher modes of operation data queue 128. LATENCY shows the maximum tolerable time of latency, and is set by the user according to the usage. Nc shows the number of lines of the data buffer 143 (number of columns), Ncbc shows the data count of the non parallel block cipher modes of operation data to be queued in the non parallel block cipher modes of operation data queue 123, Nr shows the number of rounds of the loaded encryption algorithm, and Necb shows the data count of the parallel block cipher modes of operation data to be queued in the parallel block cipher modes of operation data queue 128. Further, MAX shows the function of returning a maximum value that can be adopted by the argument, and CEIL shows the round-up function.

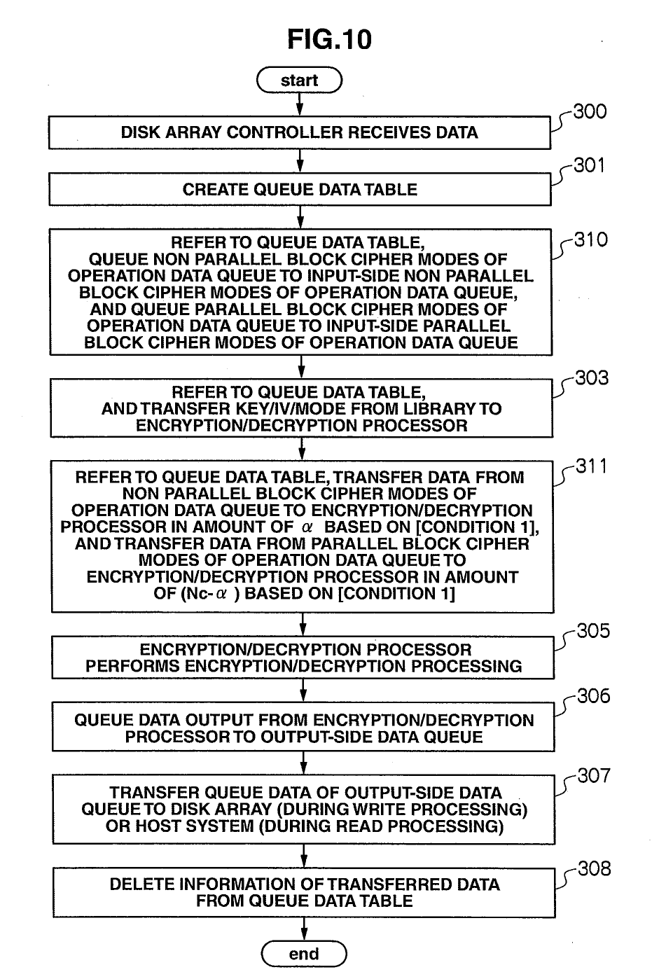

FIG. 10 shows a flowchart of the data transfer processing to be performed by the disk array controller 102, and is a processing flow where step 302 of FIG. 3 of the first embodiment is replaced with step 310, and step 304 is replaced with step 311. Step 310 and step 311 are explained below.

Foremost, the disk array controller 102, at step 310, refers to the queue data table 124, respectively distinguishes the transfer data transferred from the host system 100 when a write request is sent from the host system 100 and the transfer data transferred from the disk array 101 when a read request is sent from the host system 100, queues the transfer data in the non parallel block cipher modes of operation data queue 123 when it is non parallel block cipher modes of operation data, and queues the transfer data in the parallel block cipher modes of operation data queue 128 when it is parallel block cipher modes of operation data.

The disk array controller 102, at step 311, refers to the queue data table 124, outputs data from the non parallel block cipher modes of operation data queue 123 in a quantity of a based on Formula 1 (Condition 1), and outputs data from the parallel block cipher modes of operation data queue 128 in a quantity of (Nc−α) to the data buffer 143 in the input controller.

In other words, when it is below the LATENCY concerning ECB set forth in Formula 1 (Condition 1), the disk array controller 102 comprehends the mixture ratio of the non parallel block cipher modes of operation data and the parallel block cipher modes of operation data among the data transferred from the host system 100 by referring to the queue table 124, stores the non parallel block cipher modes of operation data in the input-side non parallel block cipher modes of operation data queue 123 in a quantity of (number of buffer columns−n) in relation to the input quantity n of the parallel block cipher modes of operation data that satisfies foregoing Condition 1, and stores the remaining parallel block cipher modes of operation data in the input-side parallel block cipher modes of operation data queue 128.

Further, when the non parallel block cipher modes of operation data is transferred to the input-side non parallel block cipher modes of operation data queue 123 in large volumes and the non parallel block cipher modes of operation data is given preference over the parallel block cipher modes of operation data based on foregoing Condition 1, and none of the parallel block cipher modes of operation data is processed and exceeds the predetermined LATENCY concerning ECB, the disk array controller 102 inputs the non parallel block cipher modes of operation data and the parallel block cipher modes of operation data in the data buffer 143 with the input quantity of the parallel block cipher modes of operation data as 1.

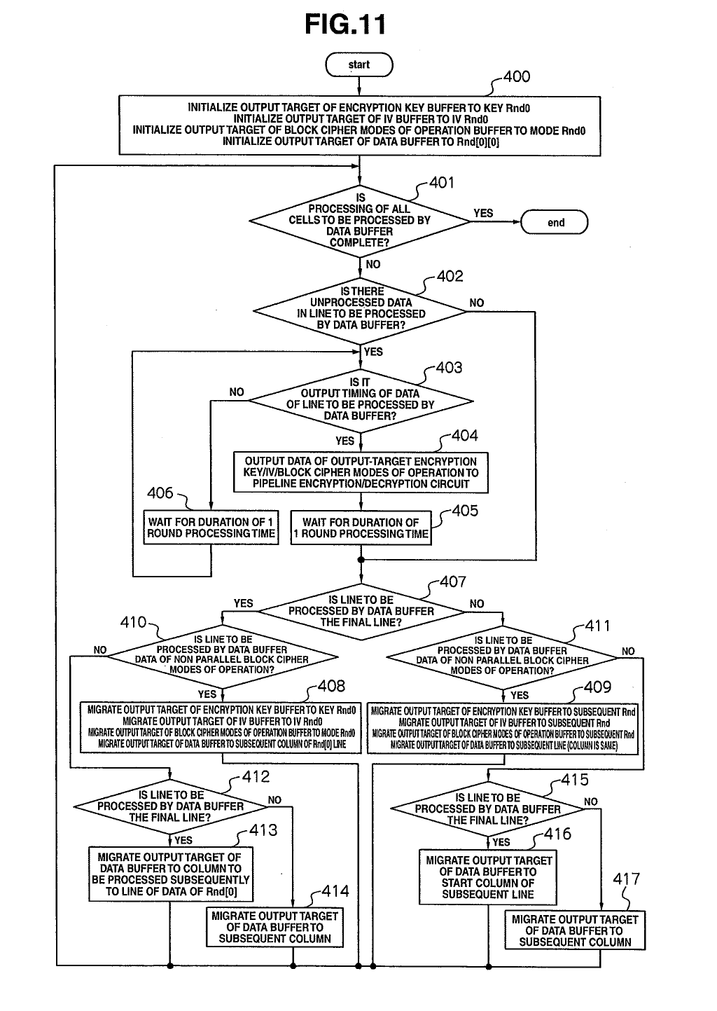

FIG. 11 shows a flowchart of the data output processing to the pipeline encryption/decryption circuit 131 to be performed by the input controller 130, and is a processing flow in which step 410 to step 417 are added to the flow of FIG. 5 of the first embodiment. Step 410 to step 417 are explained below.

The input controller 130, at step 410, determines whether the current processing target line of the data buffer 143 is data of the non parallel block cipher modes of operation, proceeds to step 408 if step 410 is true, and determines whether the current processing target column of the data buffer 143 is the final line if step 410 is false (step 412). If step 412 is true, the input controller 130 migrates the current output target of the data buffer 143 to a cell containing data to be processed subsequently among the data of Rnd[0] (step 413), and, if step 412 is false, migrates the output target of the data buffer 143 to a cell of a subsequent column of the same line (step 414).

Similarly, the input controller 130, at step 411, determines whether the current processing target line of the data buffer 143 is data of the non parallel block cipher modes of operation, proceeds to step 409 if step 411 is true, and determines whether the current processing target column of the data buffer 143 is the final line if step 410 is false (step 415). If step 415 is true, the input controller 130 migrates the current output target of the data buffer 143 to a cell of a start column of a subsequent line (step 416), and, if step 415 is false, migrates the output target of the data buffer 143 to a cell of a subsequent column of the same line (step 417).

Like this, in the present embodiment, the reason for performing different processing to the non parallel block cipher modes of operation data and the parallel block cipher modes of operation data is because the parallel block cipher modes of operation data has no dependency between the block data, and it is therefore possible to successively input the block data disposed on the same line of the data buffer 143 in the pipeline encryption/decryption circuit 131, and unnecessary wait processing time can thereby be eliminated. Incidentally, in FIG. 8, FIG. 9, FIG. 10, and FIG. 11, items with the same reference numeral as in FIG. 1, FIG. 2, FIG. 3, and FIG. 5 of the first embodiment has a common function. Further, the functions shown in FIG. 4, FIG. 6, and FIG. 7 of the first embodiment are also common in the second embodiment.

As described above, the disk array controller 102 according to the second embodiment respectively divides a plurality of non parallel mode encryption/decryption target data and a plurality of parallel mode encryption/decryption target data into a plurality of messages unrelated to the encryption/decryption processing, partitions the non parallel mode encryption/decryption target data or the parallel mode encryption/decryption target data belonging to the respective messages into a plurality of block data, encrypts/decrypts block data corresponding to a cell of the same column of each line of the messages containing the non parallel mode encryption/decryption target data when each block data belonging to the respective messages is allocated to each line of Rnd[0] to Rnd[R−1] per message simultaneously with the pipeline processing, and uses unused processing time arising during the encryption/decryption processing to encrypt/decrypt block data corresponding to a cell of the same column of each line of the messages containing the parallel mode encryption/decryption target data simultaneously with the pipeline processing. Thus, high speed encryption at a maximum of R-times faster is realized.

Here, when the data of the respective messages stored in the data buffer (input buffer) 143 has no dependency between blocks other than the data based on the non parallel block cipher modes of operation and there is data based on the parallel block cipher modes of operation that can be processed in a random sequence, the pipeline encryption/decryption circuit 131, as the encryption/decryption processor, interleavely retrieves data of the respective messages from the data buffer 143 in block units in relation to data based on the non parallel block cipher modes of operation, sequentially retrieves data of the respective messages from the data buffer 143 in block units in relation to data based on the parallel block cipher modes of operation, and executes encryption/decryption processing to the each retrieved data through a pipeline.

Further, in the second embodiment, although the input controller 130 was equipped with R-number of encryption keys, R-number of IVs, R-number of block cipher modes of operation information, and R-number of buffers capable of retaining data, if performance deterioration can be tolerated, it is possible to lower the buffer capacity to be less than R, whereby costs can be reduced. Moreover, the encryption/decryption processing throughput will be 1 to R times greater according to the buffer capacity in comparison to Patent Document 1 as the conventional technology.

Moreover, in the second embodiment, although the input ratio of the non parallel block cipher modes of operation encryption/decryption target data and the parallel block cipher modes of operation encryption/decryption target data to the data buffer 143 was an arbitrary number, when the (non parallel block cipher modes of operation encryption/decryption target data count/parallel block cipher modes of operation encryption/decryption target data count) are a constant disk array, the buffer control can be simplified and the circuit size can be reduced by partitioning the data buffer 143 into (non parallel block cipher modes of operation encryption/decryption target data count/parallel block cipher modes of operation encryption/decryption target data count).

In addition, with the second embodiment, since it is possible to simultaneously execute a plurality of non parallel block cipher modes of operation encryption/decryption target data and a plurality of parallel block cipher modes of operation encryption/decryption target data, for example, when performing encryption with AES of a 128 bit key, in comparison to the conventional technology, high speed processing at a maximum speed that is R-times the encryption algorithm is realized.

With the second embodiment, when encrypting/decrypting a plurality of block cipher modes of operation encryption/decryption target data, the user will be provided with optimal usage since latency below the threshold value set by the user will not occur in the encryption/decryption processing of one block cipher modes of operation.

What is claimed is:

1. A disk array apparatus for controlling a disk array according to a disk access request from a host system, comprising:
a transfer data management unit for sending and receiving data to and from said host system or said disk array, and, by identifying said disk access request, managing data from said host system as write transfer data when said disk access request is a write request from said host system, and managing data from said disk array as read transfer data when said disk access request is a read request from said host system;
an input buffer for dividing said write transfer data or said read transfer data under control of said transfer data management unit into a plurality of messages as data to be encrypted/decrypted, and storing said data by partitioning it into block units per message;
an encryption/decryption processor for inputting in block units said data to be encrypted/decrypted stored in said input buffer, and executing encryption/decryption processing to said data input in block units;
an output buffer for associating said data processed by said encryption/decryption processor with said host system or said disk array, and storing said data by dividing it into said plurality of messages; and
a data transfer unit for sending and receiving data to and from said host system or said disk array, and, by identifying said disk access request, transferring data of the respective messages stored in said output buffer to said disk array when said disk access request is a write request from said host system, and transferring data of the respective messages stored in said output buffer to said host system when said disk access request is a read request from said host system;
wherein, when data of the respective messages stored in said input buffer has dependency between block data and is data based on a non parallel block cipher modes of operation that must be processed in sequential order, said encryption/decryption processor interleavely retrieves data of the respective messages from said input buffer in block units, and executes encryption/decryption processing to said retrieved data through a pipeline.

2. The disk array controller according to claim 1,
wherein said input buffer divides a plurality of non parallel mode encryption/decryption target data into a plurality of messages unrelated to said encryption/decryption processing, partitions non parallel mode encryption/decryption target data belonging to the respective messages into a plurality of block data, and stores each block data belonging to the respective messages by allocating it to each line and each column per message; and
wherein said encryption/decryption processor encrypts/decrypts block data corresponding to a cell of the same column of each line of said input buffer simultaneously with said pipeline processing.

3. A disk array apparatus for controlling a disk array according to a disk access request from a host system, comprising:
a transfer data management unit for sending and receiving data to and from said host system or said disk array, and, by identifying said disk access request, managing data from said host system as write transfer data when said disk access request is a write request from said host system, and managing data from said disk array as read transfer data when said disk access request is a read request from said host system;
an input buffer for dividing said write transfer data or said read transfer data under control of said transfer data management unit into a plurality of messages as data to be encrypted/decrypted, and storing said data by partitioning it into block units per message;
an encryption/decryption processor for inputting in block units said data to be encrypted/decrypted stored in said input buffer, and executing encryption/decryption processing to said data input in block units;
an output buffer for associating said data processed by said encryption/decryption processor with said host system or said disk array, and storing said data by dividing it into said plurality of messages; and
a data transfer unit for sending and receiving data to and from said host system or said disk array, and, by identifying said disk access request, transferring data of the respective messages stored in said output buffer to said disk array when said disk access request is a write request from said host system, and transferring data of the respective messages stored in said output buffer to said host system when said disk access request is a read request from said host system;
wherein, when data of the respective messages stored in said input buffer has dependency between block data and is data based on a non parallel block cipher modes of operation that must be processed in sequential order, said encryption/decryption processor interleavely retrieves data of the respective messages from said input buffer in block units, and executes encryption/decryption processing to said retrieved data through a pipeline, and, when data of the respective messages stored in said input buffer has no dependency between blocks and includes data based on a parallel block cipher modes of operation that can be processed in a random sequence in addition to said data based on non parallel block cipher modes of operation, said encryption/decryption processor sequentially retrieves data of the respective messages from said input buffer in block units regarding said data based on parallel block cipher modes of operation, and executes encryption/decryption processing to each of said retrieved data through a pipeline.

4. The disk array controller according to claim 3,
wherein said input buffer respectively divides a plurality of non parallel mode encryption/decryption target data and a plurality of parallel mode encryption/decryption target data into a plurality of messages unrelated to said encryption/decryption processing, partitions non parallel mode encryption/decryption target data or parallel mode encryption/decryption target data belonging to the respective messages into a plurality of block data, and stores each block data belonging to the respective messages by allocating it to each line and each column per message; and
wherein said encryption/decryption processor encrypts/decrypts block data corresponding to a cell of the same column of each line of said messages containing said non parallel mode encryption/decryption target data simultaneously with said pipeline processing, and uses unused processing time arising during said encryption/decryption processing to encrypt/decrypt block data corresponding to a cell of the same column of each line of said messages containing said parallel mode encryption/decryption target data.

5. A disk array control method for sending and receiving data to and from a host system and a disk array controller, and controlling a disk array according to a disk access request from said host system,
wherein said disk array controller comprises:
a step for sending and receiving data to and from said host system or said disk array, and, by identifying said disk access request, managing data from said host system as write transfer data when said disk access request is a write request from said host system, and managing data from said disk array as read transfer data when said disk access request is a read request from said host system;
a step for dividing said write transfer data or said read transfer data under control of said step into a plurality of messages as data to be encrypted/decrypted, and storing said data in an input buffer by partitioning it into block units per message;
a step for inputting in block units said data to be encrypted/decrypted stored in said input buffer, and executing encryption/decryption processing to said data input in block units;
a step for associating said data processed by at said encryption/decryption processing step with said host system or said disk array, and storing said data in an output buffer by dividing it into said plurality of messages; and
a step for sending and receiving data to and from said host system or said disk array, and, by identifying said disk access request, transferring data of the respective messages stored in said output buffer to said disk array when said disk access request is a write request from said host system, and transferring data of the respective messages stored in said output buffer to said host system when said disk access request is a read request from said host system;
wherein, when data of the respective messages stored in said input buffer has dependency between block data and is data based on a non parallel block cipher modes of operation that must be processed in sequential order, said encryption/decryption processing execution step includes a step of interleavely retrieving data of the respective messages from said input buffer in block units, and executing encryption/decryption processing to said retrieved data through a pipeline.

6. A disk array control method for sending and receiving data to and from a host system and a disk array controller, and controlling a disk array according to a disk access request from said host system,
wherein said disk array controller comprises:
a step for sending and receiving data to and from said host system or said disk array, and, by identifying said disk access request, managing data from said host system as write transfer data when said disk access request is a write request from said host system, and managing data from said disk array as read transfer data when said disk access request is a read request from said host system;
a step for dividing said write transfer data or said read transfer data under control of said step into a plurality of messages as data to be encrypted/decrypted, and storing said data in an input buffer by partitioning it into block units per message;
a step for inputting in block units said data to be encrypted/decrypted stored in said input buffer, and executing encryption/decryption processing to said data input in block units;
a step for associating said data processed by at said encryption/decryption processing step with said host system or said disk array, and storing said data in an output buffer by dividing it into said plurality of messages; and
a step for sending and receiving data to and from said host system or said disk array, and, by identifying said disk access request, transferring data of the respective messages stored in said output buffer to said disk array when said disk access request is a write request from said host system, and transferring data of the respective messages stored in said output buffer to said host system when said disk access request is a read request from said host system;
wherein, when data of the respective messages stored in said input buffer has dependency between block data and is data based on a non parallel block cipher modes of operation that must be processed in sequential order, said encryption/decryption processing execution step includes a step of interleavely retrieving data of the respective messages from said input buffer in block units, and executing encryption/decryption processing to said retrieved data through a pipeline, and, when data of the respective messages stored in said input buffer has no dependency between blocks and includes data based on a parallel block cipher modes of operation that can be processed in a random sequence in addition to said data based on non parallel block cipher modes of operation, said encryption/decryption processing execution step includes a step of sequentially retrieving data of the respective messages from said input buffer in block units regarding said data based on parallel block cipher modes of operation, and executing encryption/decryption processing to each of said retrieved data through a pipeline.

7. A storage system comprising a host system, and a disk array controller for sending and receiving data to and from said host system via a communication network and controlling a disk array according to a disk access request from said host system,
said disk array controller comprising:
a transfer data management unit for sending and receiving data to and from said host system or said disk array, and, by identifying said disk access request, managing data from said host system as write transfer data when said disk access request is a write request from said host system, and managing data from said disk array as read transfer data when said disk access request is a read request from said host system;
an input buffer for dividing said write transfer data or said read transfer data under control of said transfer data management unit into a plurality of messages as data to be encrypted/decrypted, and storing said data by partitioning it into block units per message;
an encryption/decryption processor for inputting in block units said data to be encrypted/decrypted stored in said input buffer, and executing encryption/decryption processing to said data input in block units;
an output buffer for associating said data processed by said encryption/decryption processor with said host system or said disk array, and storing said data by dividing it into said plurality of messages; and
a data transfer unit for sending and receiving data to and from said host system or said disk array, and, by identifying said disk access request, transferring data of the respective messages stored in said output buffer to said disk array when said disk access request is a write request from said host system, and transferring data of the respective messages stored in said output buffer to said host system when said disk access request is a read request from said host system;
wherein, when data of the respective messages stored in said input buffer has dependency between block data and is data based on a non parallel block cipher modes of operation that must be processed in sequential order, said encryption/decryption processor interleavely retrieves data of the respective messages from said input buffer in block units, and executes encryption/decryption processing to said retrieved data through a pipeline.

8. The storage system according to claim 7,
wherein said input buffer divides a plurality of non parallel mode encryption/decryption target data into a plurality of messages unrelated to said encryption/decryption processing, partitions non parallel mode encryption/decryption target data belonging to the respective messages into a plurality of block data, and stores each block data belonging to the respective messages by allocating it to each line and each column per message; and
wherein said encryption/decryption processor encrypts/decrypts block data corresponding to a cell of the same column of each line of said input buffer simultaneously with said pipeline processing.

9. A storage system comprising a host system, and a disk array controller for sending and receiving data to and from said host system via a communication network and controlling a disk array according to a disk access request from said host system,
said disk array controller comprising:
a transfer data management unit for sending and receiving data to and from said host system or said disk array, and, by identifying said disk access request, managing data from said host system as write transfer data when said disk access request is a write request from said host system, and managing data from said disk array as read transfer data when said disk access request is a read request from said host system;
an input buffer for dividing said write transfer data or said read transfer data under control of said transfer data management unit into a plurality of messages as data to be encrypted/decrypted, and storing said data by partitioning it into block units per message;
an encryption/decryption processor for inputting in block units said data to be encrypted/decrypted stored in said input buffer, and executing encryption/decryption processing to said data input in block units;
an output buffer for associating said data processed by said encryption/decryption processor with said host system or said disk array, and storing said data by dividing it into said plurality of messages; and
a data transfer unit for sending and receiving data to and from said host system or said disk array, and, by identifying said disk access request, transferring data of the respective messages stored in said output buffer to said disk array when said disk access request is a write request from said host system, and transferring data of the respective messages stored in said output buffer to said host system when said disk access request is a read request from said host system;
wherein, when data of the respective messages stored in said input buffer has dependency between block data and is data based on a non parallel block cipher modes of operation that must be processed in sequential order, said encryption/decryption processor interleavely retrieves data of the respective messages from said input buffer in block units, and executes encryption/decryption processing to said retrieved data through a pipeline, and, when data of the respective messages stored in said input buffer has no dependency between blocks and includes data based on a parallel block cipher modes of operation that can be processed in a random sequence in addition to said data based on non parallel block cipher modes of operation, said encryption/decryption processor sequentially retrieves data of the respective messages from said input buffer in block units regarding said data based on parallel block cipher modes of operation, and executes encryption/decryption processing to each of said retrieved data through a pipeline.

10. The storage system according to claim 9,
wherein said input buffer respectively divides a plurality of non parallel mode encryption/decryption target data and a plurality of parallel mode encryption/decryption target data into a plurality of messages unrelated to said encryption/decryption processing, partitions non parallel mode encryption/decryption target data or parallel mode encryption/decryption target data belonging to the respective messages into a plurality of block data, and stores each block data belonging to the respective messages by allocating it to each line and each column per message; and
wherein said encryption/decryption processor encrypts/decrypts block data corresponding to a cell of the same column of each line of said messages containing said non parallel mode encryption/decryption target data simultaneously with said pipeline processing, and uses unused processing time arising during said encryption/decryption processing to encrypt/decrypt block data corresponding to a cell of the same column of each line of said messages containing said parallel mode encryption/decryption target data.
